(19) United States
(12) Patent Application Publication
(10) Pub. No.: US 2019/0391352 A1
(43) Pub. Date: Dec. 26, 2019

(54) COMPACT HORIZONTAL BACKBONE ROLLABLE RIBBON CABLES FOR PREMISES OPTICAL CABLING APPLICATIONS

(71) Applicant: OFS Fitel, LLC, Norcross, GA (US)

(72) Inventors: Annabelle Scarpaci, Austell, GA (US); Henson P. Toland, Atlanta, GA (US); Peter A. Weimann, Atlanta, GA (US)

(73) Assignee: OFS Fitel, LLC, Norcross, GA (US)

(21) Appl. No.: 16/561,426

(22) Filed: Sep. 5, 2019

Related U.S. Application Data
(63) Continuation-in-part of application No. 15/670,279, filed on Aug. 7, 2017, now Pat. No. 10,444,460.
(60) Provisional application No. 62/484,081, filed on Apr. 11, 2017.

(51) Int. Cl. G02B 6/44

(52) U.S. Cl. CPC G02B 6/4432

(57) ABSTRACT

An optical fiber cable includes a rollable ribbon, reinforcing yarns, and a jacket. The Rollable ribbon has a plurality of optical fibers. Each optical fiber has a fiber strain greater than 0.6 percent under standard installation tensile load. The jacket encloses the rollable ribbon, the optical fibers and reinforcing yarns at a packing density greater than about 1.25 fibers per square millimeter. The combined effect of optical fibers having a fiber strain greater than 0.6 percent under standard installation tensile load and a small amount of reinforcing yarn provides the optical fiber cable with high proof strain, compact diameter, and high packing density.

### CROSS-REFERENCE TO RELATED APPLICATIONS

This application is a Continuation-In-Part of Non-Provisional U.S. patent application Ser. No. 15/670,279, which was filed on Aug. 7, 2017 and has the title “COMPACT HORIZONTAL BACKBONE CABLES FOR PREMISES OPTICAL CABLING APPLICATIONS.”

### BACKGROUND

An optical fiber distribution cable generally comprises two or more optical fibers enclosed within a jacket. Cables designed for long horizontal runs in overhead ladder racks and underfloor trays in service provider central office and data center facilities, commonly referred to as horizontal backbone cables, have high tensile strength to withstand the pull tension of the installation process and high stiffness to promote crush and kink resistance and protect the relatively fragile glass optical fibers. To provide tensile strength, Kevlar® or other aramid yarn may be included in the cable in the form of a reinforcing layer between the fibers and the jacket. To provide crush and kink resistance, an acrylate matrix layer may be provided between the fibers and the aramid yarn layer. An example of such a cable is the OFS AccuPack® cable, available with 24 fibers in a 5.4 mm diameter and with 12 fibers in a 4.5 mm diameter.

As bandwidth demands continue to increase, service providers and data center operators often must serve ever more data from existing physical facilities, such as central offices and edge data centers. These facilities have limited capacity for cabling in existing overhead ladder racks and underfloor trays. To accommodate increasing bandwidth demands with existing rack and tray capacity, the fiber packing density of cables used in these environments may be increased. The outside diameter of the cable is a limiting factor on the fiber packing density, i.e., number of optical fibers that can be included. Increasing the packing density without increasing the cable diameter leaves less space for aramid reinforcing yarn.

Flaws on the surface of glass optical fibers can cause the fiber to break at a relatively low level of tensile strain. As described in International Electrotechnical Commission (IEC) Technical Recommendation 62048, the larger the flaw, the lower the strain required to cause the fiber to break. In order to screen out such flaws, conventional optical fibers with a glass cladding diameter of 125 microns are typically subjected to a proof test during the manufacturing process. As described in standards such as IEC 60793-2-59 and Telcordia GR-20, the standard proof test force for conventional optical fiber with 125 micron diameter glass is 0.69 gigapascal (GPa), resulting in a proof strain of 1.0 percent.

Optical fibers must be packaged in cables that provide mechanical protection against crushing and tensile loads. Common North American industry standards, such as Telcordia GR-409 or ANSI/ICEA S-83-596, require that cables be designed so that the maximum strain on the fiber during installation be less than 0.6 percent of the fiber proof strain. This limit provides a factor of safety during field installation. For the case of conventional fiber with a glass diameter of 125 microns proof tested at 0.69 GPa load, this means a fiber strain limit of 0.6 percent at standard installation tensile load.

North American industry standard installation tensile load requirements for optical fiber backbone cables are 440 Newtons (N) for a fiber in a cable having twelve or fewer fibers, and 660 N for a fiber in a cable having more than twelve fibers. Providing a compact, i.e., small diameter, optical fiber cable that meets these requirements presents challenges, which may be addressed by the present invention in the manner described below.

### SUMMARY

Embodiments of the invention relate to compact, high packing density, high tensile load strength rollable ribbon optical fiber cables. In an exemplary embodiment, an optical fiber cable may comprise a rollable ribbon in which a plurality of optical fibers is partially bonded together, each having a fiber strain greater than 0.6 percent while under standard installation tensile load for a horizontal backbone cable, in combination with a plurality of reinforcing yarns and a jacket. The jacket encloses the plurality of optical fibers and plurality of reinforcing yarns at a packing density greater than 1.25 fibers per square millimeter.

Other systems, methods, features, and advantages will be or become apparent to one of skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is cross-sectional view of a compact optical fiber backbone cable, in accordance with exemplary embodiments of the invention.

FIG. 2 is cross-sectional view of another compact optical fiber backbone cable, in accordance with exemplary embodiments of the invention.

FIG. 3 is cross-sectional view of a compact rollable ribbon optical fiber backbone cable, in accordance with exemplary embodiments of the invention.

FIG. 4 is a top plan view of a portion of rollable optical fiber ribbon, in accordance with exemplary embodiments of the invention.

FIG. 5 is an end view of a portion of rollable optical fiber ribbon, in accordance with exemplary embodiments of the invention.

FIG. 6 is cross-sectional view of another compact rollable ribbon optical fiber backbone cable, in accordance with exemplary embodiments of the invention.

### DETAILED DESCRIPTION

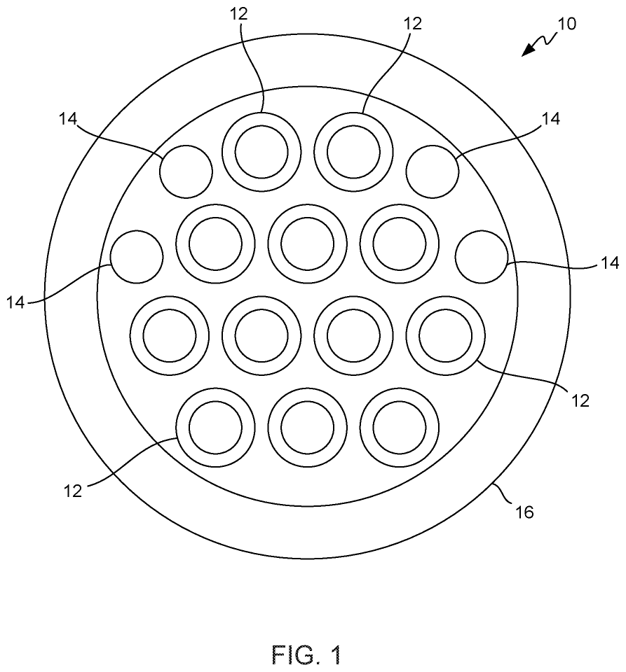

As illustrated in FIG. 1 (not to scale), in an illustrative or exemplary embodiment of the invention, an optical fiber cable 10 includes a plurality of optical fibers 12. Each optical fiber 12 has a fiber strain greater than 0.6 percent under standard installation tensile load. As well understood by one of ordinary skill in the art, the fiber strain under standard installation tensile load of each of optical fibers 12 can be measured using the procedure set forth in TIA-455-38 (“Measurement of Fiber Strain in Cables Under Tensile Load”). As the term is used herein, “standard installation tensile load” means 440 N for a fiber in a horizontal backbone cable having twelve or fewer fibers, and 660 N for a fiber in a horizontal backbone cable having more than twelve fibers, as defined in the Telcordia GR-409 and ANSI/ICEA S-83-596 standards for indoor cable.

Although for practical reasons proof testing may be limited to fiber manufacturing contexts, it may be noted that an optical fiber 12 that has been proof tested to a strain greater than one percent (or load greater than 0.69 GPa) is allowed by common industry standards to have a fiber strain greater than 0.6 percent under standard installation tensile load. Accordingly, measuring fiber strain of optical fibers 12 under standard installation tensile load may obviate or serve as a proxy for proof testing.

Each optical fiber 12 may have a cladding diameter of about 125 μm (micrometers or “microns”) and an overall or coated diameter of about 250 μm, although in other embodiments of the invention other fiber diameters may be suitable. Optical fiber cable 10 further includes a plurality of reinforcing yarns 14 and a jacket 16. Jacket 16 encloses the plurality of optical fibers 12 and the plurality of reinforcing yarns 14 such that fibers 12 are packed at a packing density greater than about 1.25 fibers per square millimeter (per mm²). The high fiber strain under standard installation tensile load of greater than 0.6 percent enables the foregoing configuration to include less reinforcing yarn than conventional wisdom would suggest. Reducing the amount of reinforcing yarn enables the above-referenced high fiber packing density of greater than about 1.25 fibers per mm².

In one example, the plurality of optical fibers 12 comprises no more than twelve (12) optical fibers 12. In this example, reinforcing yarn 14 comprises aramid yarn with a total linear density of approximately 5680 denier. The 5680 denier aramid reinforcing yarns 14 may consist of, for example, four (4) strands of 1420 denier high-modulus aramid yarn, such as DuPont Kevlar® 49 or Teijin Twaron® Type 2200 (i.e., 1420×4=5680.) This enables optical fiber cable 10 to meet the North American industry standard installation tensile load of 440 N at a fiber strain greater than 0.6 percent. In this example, jacket 16 may define the outside diameter of the optical fiber cable 10 at 3.0 mm.

In the example shown in FIG. 1, optical fiber cable 10 consists of: no more than twelve optical fibers 12, each having a coated diameter of 250 μm, each having a fiber strain greater than 0.6 percent under standard installation tensile load; four strands of 1420 denier aramid yarn 14; and a jacket 16 enclosing optical fibers 12 and reinforcing yarns 14 to define an outside diameter of optical fiber cable 10 of 3 mm. In the example shown in FIG. 1, optical fiber cable 10 has exactly twelve optical fibers 12. In still other examples (not shown), the no more than twelve optical fibers 12 may consist of exactly two optical fibers 12, exactly four optical fibers 12, exactly six optical fibers 12, or exactly eight optical fibers 12.

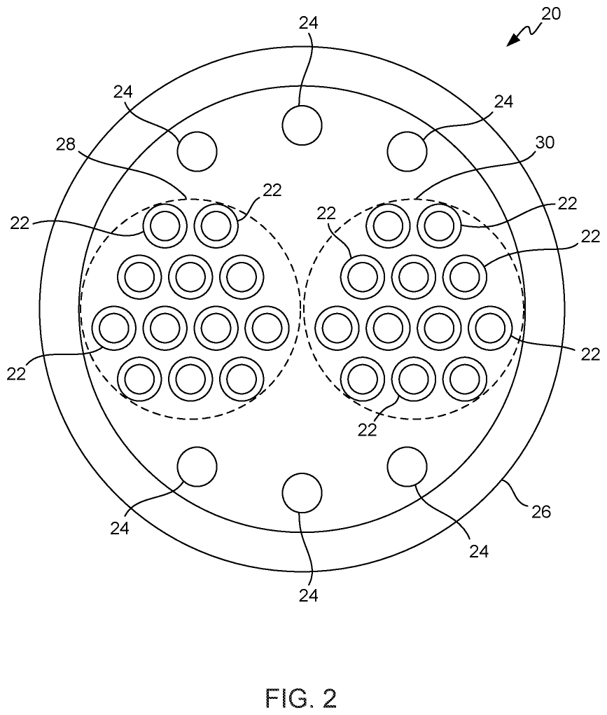

As illustrated in FIG. 2 (not to scale), in another exemplary embodiment of the invention, an optical fiber cable 20 includes a plurality of optical fibers 22. Each optical fiber 22 has a fiber strain greater than 0.6 percent under standard installation tensile load. Each optical fiber 22 may have a cladding diameter of about 125 μm and an overall or coated diameter of about 250 μm. Optical fiber cable 20 further includes a plurality of reinforcing yarns 24 and a jacket 26. Jacket 26 encloses the plurality of optical fibers 22 and plurality of reinforcing yarns 24 such that fibers 22 are packed at a packing density greater than about 1.25 fibers per mm². The high fiber strain of greater than 0.6 percent under standard installation tensile load enables the foregoing configuration to include less reinforcing yarn than conventional wisdom would suggest. Reducing the amount of reinforcing yarn enables the above-referenced high fiber packing density of greater than about 1.25 fibers per mm².

In one example, the plurality of optical fibers 22 comprises more than twelve (12) optical fibers 22. Optical fibers 22 may be configured in two bundles 28 and 30. Bundles 28 and 30 may be wound with colored bundling threads (not shown) to aid identification. The bundle threads are applied with a tight pitch, allowing for easy separation of bundles 28 and 30 when jacket 26 is removed for cable termination. Alternately, fibers 13-24 may be identified by dash marks (not shown) printed on the optical fibers. In this example, reinforcing yarn 24 comprises a linear density of approximately 8520 denier aramid yarn. The plurality of 8520 denier aramid reinforcing yarns 24 may consist of, for example, six (6) strands of 1420 denier high-modulus aramid yarn, such as DuPont Kevlar® 49 or Teijin Twaron® Type 2200 (i.e., 1420×6=8520). This enables optical fiber cable 20 to meet the North American industry standard installation tensile load of 660 N. In this example, jacket 26 may define the outside diameter of the optical fiber cable 20 at 3.8 mm.

In the example shown in FIG. 2, optical fiber cable 20 consists of: more than twelve (12) but less than or equal to twenty-four (24) optical fibers 22, each having a coated or overall diameter of 250 μm, each having a fiber strain greater than 0.6 percent under standard installation tensile load; six strands of 1420 denier aramid yarn 24; and a jacket 26 enclosing optical fibers 22 and reinforcing yarns 24 to define an outside diameter of the optical fiber cable 20 of 3.8 mm. In the example shown in FIG. 2, optical fiber cable 20 has exactly twenty-four (24) optical fibers 22. In still another other example (not shown), the more than twelve (12) but less than or equal to twenty-four (24) optical fibers 22 may consist of exactly sixteen (16) optical fibers 22.

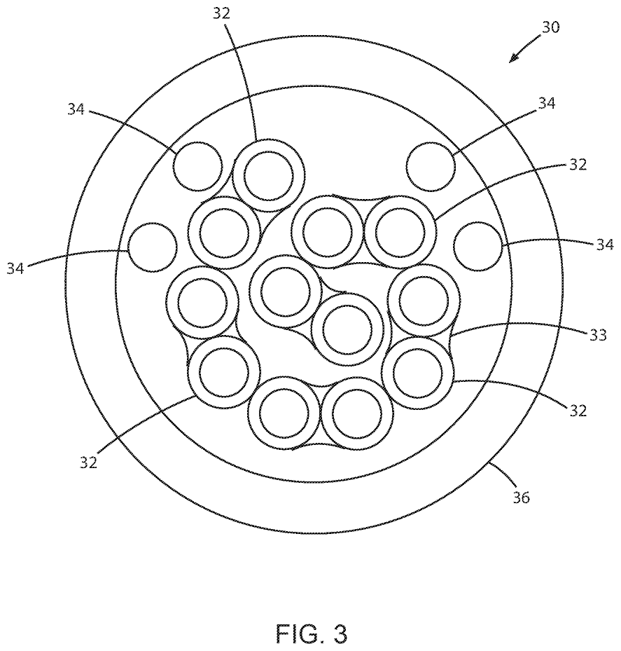

As illustrated in FIG. 3 (not to scale), in another exemplary embodiment of the invention, an optical fiber cable 30 includes a “rollable” optical fiber ribbon 33, a plurality of reinforcing yarns 34 and a cable jacket 36.

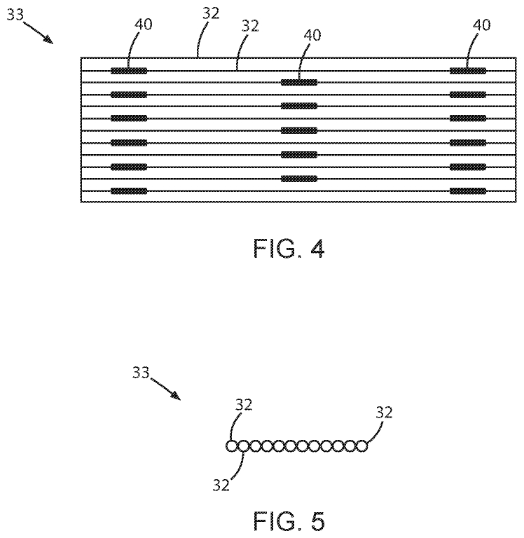

Rollable optical fiber ribbons are partially bonded optical fiber ribbons; an exemplary one of which is shown in FIGS. 4-5. As shown in FIGS. 4-5, the rollable ribbon 33 arranges the plurality of optical fibers 32 adjacent to one another in a linear array and partially bonds at least a portion of at least two adjacent optical fibers in the linear array by a matrix material 40. Unlike a traditional “flat” type of optical fiber ribbon where a matrix material fully encapsulates the fibers together, the matrix material in a rollable ribbon is intermittently distributed along the fibers. Such partial bonding provides sufficient flexibility to roll up the rollable ribbon about an axis parallel to the plurality of fibers or otherwise compact the ribbon into a fiber bundle with a roughly cylindrical shape. The ability to roll up the rollable ribbon significantly increases fiber packing density. Also, two or more rollable ribbons can be grouped together into a compact bundle parallel to the axis of the fibers.

Going back to FIG. 3, the rollable ribbon 33 partially bonds a plurality of optical fibers 32 along the length of the optical fibers with a matrix material. Each optical fiber 32 has a fiber strain greater than 0.6 percent under standard installation tensile load. Each optical fiber 32 may have a cladding diameter of about 125 μm and an overall or coated diameter of about 250 μm.

Cable jacket 36 encloses the rollable ribbon 33 and plurality of reinforcing yarns 34 such that fibers 32 are packed at a packing density greater than about 1.25 fibers per mm² with respect to the cable jacket 36. The cable jacket 36 defines an outer jacket of the optical fiber cable 30. The high fiber strain of greater than 0.6 percent under standard installation tensile load enables the foregoing configuration to include less reinforcing yarn than conventional wisdom would suggest. Reducing the amount of reinforcing yarn enables the above-referenced high fiber packing density of greater than about 1.25 fibers per mm².

In one example, the plurality of optical fibers 32 comprises no more than twelve (12) optical fibers 32. The no more than twelve (12) optical fibers 32 are partially bonded to each other in a rollable ribbon 33. In this example, reinforcing yarn 34 comprises aramid yarn with a total linear density of approximately 5680 denier. The 5680 denier aramid reinforcing yarns 34 may consist of, for example, four (4) strands of 1420 denier high-modulus aramid yarn, such as DuPont Kevlar® 49 or Teijin Twaron® Type 2200 (i.e., 1420×4=5680.) This enables optical fiber cable 30 to meet the North American industry standard installation tensile load of 440 N at a fiber strain greater than 0.6 percent. In this example, jacket 36 may define the outside diameter of the optical fiber cable 10 at 3.0 mm.

In the example shown in FIG. 3, optical fiber cable 30 consists of: no more than twelve optical fibers 32, each having a coated diameter of 250 μm, each having a fiber strain greater than 0.6 percent under standard installation tensile load; a rollable ribbon 33 that partially bonds the optical fibers 32; four strands of 1420 denier aramid yarn 34; and a cable jacket 36 enclosing the rollable ribbon 33 and reinforcing yarns 34 to define an outside diameter of optical fiber cable 30 of 3 mm. In the example shown in FIG. 3, optical fiber cable 30 has exactly twelve optical fibers 32. In still other examples (not shown), the no more than twelve optical fibers 32 may consist of exactly two optical fibers 32, exactly four optical fibers 32, exactly six optical fibers 32, or exactly eight optical fibers 32.

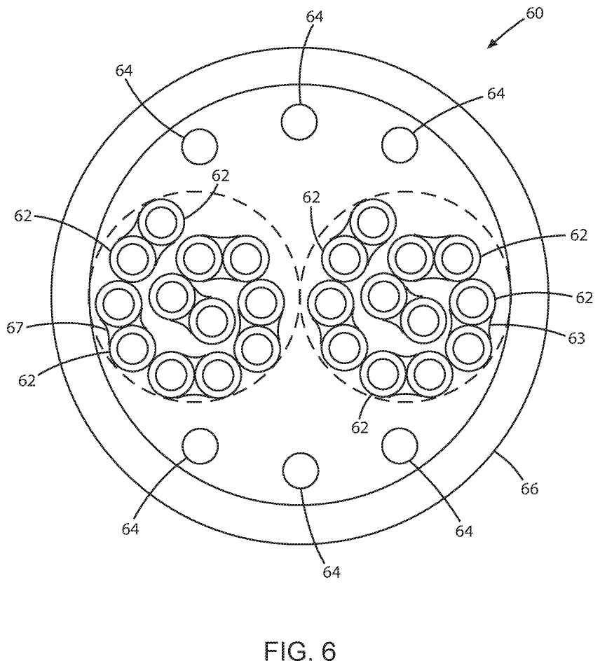

As illustrated in FIG. 6 (not to scale), in another exemplary embodiment of the invention, an optical fiber cable 60 includes a plurality of “rollable” optical fiber ribbons 63 and 67, a plurality of reinforcing yarns 64 and a jacket 66. In this example, the plurality of optical fibers 62 comprises more than twelve (12) optical fibers 62. Optical fibers 62 may be configured in two groups. The first group may be partially bonded by a first rollable ribbon 63 and the second group may be partially bonded by a second rollable ribbon 67. In this example, reinforcing yarn 64 comprises a linear density of approximately 8520 denier aramid yarn. The plurality of 8520 denier aramid reinforcing yarns 64 may consist of, for example, six (6) strands of 1420 denier high-modulus aramid yarn, such as DuPont Kevlar® 49 or Teijin Twaron® Type 2200 (i.e., 1420×6=8520). This enables optical fiber cable 60 to meet the North American industry standard installation tensile load of 660 N. In this example, cable jacket 66 may define the outside diameter of the optical fiber cable 60 at 3.8 mm.

In the example shown in FIG. 6, optical fiber cable 60 consists of: more than twelve (12) but less than or equal to twenty-four (24) optical fibers 62, each having a coated or overall diameter of 250 μm, each having a fiber strain greater than 0.6 percent under standard installation tensile load; first and second rollable ribbons 63 and 67 where the first rollable ribbon 63 partially bonds a first group of optical fibers 62 and the second rollable ribbon 67 partially bonds a first group of optical fibers 62; six strands of 1420 denier aramid yarn 64; and a jacket 66 enclosing optical fibers 62 and reinforcing yarns 64 to define an outside diameter of the optical fiber cable 60 of 3.8 mm. In the example shown in FIG. 6, optical fiber cable 60 has exactly twenty-four (24) optical fibers 62. In still another other example (not shown), the more than twelve (12) but less than or equal to twenty-four (24) optical fibers 62 may consist of exactly sixteen (16) optical fibers 62.

One or more illustrative or exemplary embodiments of the invention have been described above. In accordance with the exemplary embodiments, compactness and a high allowable strain limit are achieved by a combination of optical fibers that are compact yet tested to high proof strain and a relatively small amount of reinforcing yarn. However, it is to be understood that the invention is defined by the appended claims and is not limited to the specific embodiments described.

What is claimed is:

1. An optical fiber cable, comprising:
a plurality of optical fibers, having a fiber strain greater than 0.6 percent under standard installation tensile load;
a rollable ribbon in which the plurality of optical fibers is partially bonded together;
a plurality of reinforcing yarns; and
a cable jacket defining an outer jacket of the optical fiber cable and enclosing the plurality of optical fibers and plurality of reinforcing yarns,
wherein the plurality of optical fibers is enclosed with respect to the cable jacket at a packing density greater than about 1.25 fibers per square millimeter.

2. The optical fiber cable of claim 1, wherein each optical fiber has a cladding diameter of about 125 micrometers.

3. The optical fiber cable of claim 1, wherein each optical fiber has a coated diameter of about 250 micrometers.

4. The optical fiber cable of claim 1, wherein:
the plurality of optical fibers comprises no more than 12 optical fibers;
the plurality of reinforcing yarns comprises 5680 denier; and
the cable jacket defines an outside diameter of the optical fiber cable of about 3 millimeters,
wherein the standard tensile load for this cable configuration is 440 Newton.

5. The optical fiber cable of claim 4, wherein the plurality of reinforcing yarns consists of 4 strands of 1420 denier aramid yarn.

6. The optical fiber cable of claim 1, wherein:
the plurality of optical fibers comprises more than 12 optical fibers;
the plurality of reinforcing yarns comprises 8520 denier; and
the cable jacket defines an outside diameter of the optical fiber cable of 3.8 millimeters,
wherein the standard tensile load for this cable configuration is 660 Newton.

7. The optical fiber cable of claim 6, wherein the plurality of reinforcing yarns consists of 6 strands of 1420 denier aramid yarn.

8. The optical fiber cable of claim 6, wherein the plurality of optical fibers is separated into two or more groups and each group of fibers are partially bonded by one rollable ribbon.

9. The optical fiber cable of claim 1, wherein the rollable ribbon arranges the plurality of optical fibers adjacent to one another in a linear array and partially bonds at least a portion of at least two adjacent optical fibers in the linear array by a matrix material.

10. The optical fiber cable of claim 1, wherein the partial bonding in the rollable ribbon provides sufficient flexibility to roll up the rollable ribbon about an axis parallel to the plurality of fibers.

11. The optical fiber cable of claim 1, wherein no tensile reinforcement except the reinforcing yarns is contained within the cable jacket.

12. An optical fiber cable, consisting of:
no more than 12 optical fibers, each having a fiber strain greater than 0.6 percent under an installation tensile load of 440 Newton;
a rollable ribbon in which the no more than 12 optical fibers are partially bonded together;
4 strands of 1420 denier aramid yarn; and
a jacket enclosing the no more than 12 optical fibers and 4 strands of aramid yarn to define an outside diameter of the optical fiber cable of about 3 millimeters.

13. The optical fiber cable of claim 12, wherein each optical fiber has a cladding diameter of about 125 micrometers.

14. The optical fiber cable of claim 12, wherein each optical fiber has a coated diameter of about 250 micrometers.

15. An optical fiber cable, consisting of:
more than 12 optical fibers, each having a fiber strain greater than 0.6 percent under an installation tensile load of 660 Newton;
a first rollable ribbon in which a first group of the more than 12 optical fibers is partially bonded together;
a second rollable ribbon in which a second group of the more than 12 optical fibers is partially bonded together;
6 strands of 1420 denier aramid yarn; and
a jacket enclosing the more than 12 optical fibers and 6 strands of aramid yarn to define an outside diameter of the optical fiber cable of about 3.8 millimeters.

16. The optical fiber cable of claim 15, wherein each optical fiber has a cladding diameter of about 125 micrometers.

17. The optical fiber cable of claim 15, wherein each optical fiber has a coated diameter of about 250 micrometers.
